(19) United States
(12) Patent Application Publication
(10) Pub. No.: US 2016/0239835 A1
(43) Pub. Date: Aug. 18, 2016

(54) Method for End to End Encryption of Payment Terms for Secure Financial Transactions

(71) Applicant: Pocket Systems, Inc., Woodside, CA (US)

(72) Inventor: David John MARSYLA, Woodside, CA (US)

(73) Assignee: Pocket Systems, Inc.

(21) Appl. No.: 14/622,601

(22) Filed: Feb. 13, 2015

(51) Int. Cl. G06Q 20/38; G06Q 20/20

(52) U.S. Cl. CPC G06Q 20/3829; G06Q 20/202

(57) ABSTRACT

The present invention provides a means for true end-to-end encryption of the financial terms and payment information for a financial transaction. Through the use of a secure device belonging to a customer, and a corresponding decryption server deployed at a credit card issuing bank, or other trusted authority, it is possible to encrypt transaction in such a way so that no other party can decrypt the information. Further, by encrypting the payment information along with a merchant identifier, and other unique terms of the transaction, it is possible to create a unique payment token that cannot be stolen and re-used in a fraudulent manner. This new level of security can be achieved simply using standard payment formats that are already supported by merchants, gateways and card networks.

### FIELD OF THE INVENTION

Embodiments of the present invention relate to the field of secure financial transactions, and more particularly, to a small, personal hardware device for encrypting financial transaction data to provide end to end security.

### BACKGROUND OF THE INVENTION

It is widely understood that theft of consumer credit card information is a growing and expensive problem in society. Many attempts have been made to secure or obscure the transfer of customer financial information, but most approaches have proven to be easily defeated by determined hackers, resulting in high costs to financial institutions and consumers alike.

Current approaches to address this problem often focus on adding additional security to merchant in-store point of sale terminals so that transactions can be encrypted as they pass through a merchant system, and then decrypted as they are transferred to a merchant payment gateway. This has been referred to as end-to-end encryption, but in actuality, this leaves the payment information vulnerable both inside the point of sale terminal, and again as the information is being passed to the merchant gateway and beyond.

Online merchants who accept payments through a web site or mobile application have also taken similar approaches to try and encrypt payment information from the moment it arrives at their application server, until it is passed to the merchant payment gateway. Again, this leaves the payment information vulnerable as it arrives in their systems, and as it is passed to the gateway.

In most of these current approaches, the ability to decrypt the transaction must be present within the merchant's technology infrastructure, which creates another vulnerability that can be exploited.

Also, in many cases, in-store and online merchants retain the customer's payment information in a format that can be decrypted on-site, in order to perform ongoing analysis of customer purchasing behavior. This desire for customer analytics is often the largest source of vulnerability in a merchant's infrastructure.

Therefore, there is a need to create a new system that provides true end to end security by encrypting financial transactions before they are given to the merchant, using a technique that cannot be broken, and can only be decrypted by a trusted authority (generally the bank or entity that issued the payment card).

A new system should also be compatible with current credit card processing systems, and provide enough visibility into the customer identity so that merchants can support the system easily without losing their analytics capabilities.

To achieve these goals, the current card payment information presented by customers must be replaced by an encrypted payment token. To achieve true end-to-end encryption, the payment token should be generated by a device in the possession of the customer, in a manner that is impossible to impersonate. The encrypted token must only be usable for a single transaction, and must contain enough information about the terms of the transaction, including at least a merchant identifier and a transaction identifier, so that the information cannot be stolen and re-used by a thief for any other purpose than the intended transaction.

### SUMMARY OF THE INVENTION

The present invention provides a means for true end-to-end encryption of the financial terms and payment information for a financial transaction. In order to support this, the current process of a customer blindly presenting valuable payment information to a merchant must be altered, and instead a merchant must first present identification and payment terms to the customer. The customer can then combine their payment information, along with the provided merchant identification and terms into a one-time use encrypted token using a secure hardware device in the customer's possession.

This secure hardware device is pre-loaded with enough unique encryption keys for a lifetime of transactions for a single customer. Only the payment card issuing bank or other trusted authority should have access to the corresponding keys and the ability to decipher the encrypted token.

The encrypted payment is then combined with a “fake” credit card number, or tokenized account number to identify the customer, that cannot be used alone for any other type of payment. This tokenized account number should be unique to the customer, and can be used to route the transaction from a merchant to the proper card issuing bank (e.g. Wells Fargo), typically through a merchant gateway (e.g. Authorize.net) and a card network (e.g. Visa, MasterCard). In some embodiments, the authority that issues the cards and approves transactions may be a card network (e.g. American Express) or a merchant who issues their own debit cards (e.g. Target Stores).

The combined routing and encrypted information is formatted to look like a standard credit card payment that might have been read from a plastic card's magnetic stripe (referred to as Track 1 data format). Although the new payment token resembles Track 1 magnetic data in its format, it is dynamically generated and unique for each transaction, and cannot be copied and re-used like a standard credit card.

This new combined payment token can be presented electronically to either in-store or online merchants, and remains in encrypted format at every point in the processing system until it is necessary for the card issuing authority to authorize the payment. Only the card issuing authority, or another trusted authority such as a credit card network, can decrypt the transaction and map the tokenized account number back to the customer's actual account. No other party in the system needs to have access to the customer's account information, or the decrypted version of the payment token.

If properly implemented, using the strongest form of encryption, this approach will deter any attempt to steal customer payment information. As long as the encrypted payment token contains reference to the merchant, and information unique to the transaction, it cannot be used by a thief as payment for any other goods or services, and is pointless to steal.

There are many types of encryption which would be extremely difficult for a thief to break, but there is only one type of encryption that is provably impossible to impersonate without access to the original encryption keys. This encryption technique is called a One Time Pad encryption and uses a unique random encryption key for each transaction.

The random encryption keys are pre-loaded on the customer's device, and are also made available to the authority that will decrypt the transaction. Each encryption key is at least as large as the information being encrypted, and has no relationship to keys used in previous transactions. It is therefore impossible to predict what key would be valid for a new transaction, even if a thief had access to every transaction previously made and infinite computing power.

Although the One Time Pad approach guarantees a key cannot be guessed before a transaction is encrypted, it is also necessary to ensure that a newly submitted transaction cannot be decoded in an attempt to alter the transaction terms to a thief's benefit. Therefore, a modified form of One Time Pad encryption, such as Transaction Pad Encryption, should be used. Transaction Pad Encryption is an ideal format for a financial token since it uses a one-time use encryption key larger than the size of the data being encrypted. Part of the encryption key is used to mask the information like a standard One Time Pad encryption, and a hidden part of the key is used to scramble the data completely.

By using an encryption key significantly larger than the encrypted data, anyone attempting to derive the key from the data (even if all of the underlying data is known) will find that there are millions of possible keys which could have been used to generate the encrypted message. Of the millions of possible keys that could have generated the message, only a small number of those could be used to re-encrypt a modified message correctly without being easily detected.

This true end-to-end encryption approach has the added benefit of removing the need for merchants to provide additional encryption or transaction security for payments generated in this manner. If all payments are generated in this manner, merchant requirements for protecting payment information, such as PCI DSS, will not be necessary since the information could no longer be stolen and re-used fraudulently.

Additionally, although the tokenized routing number cannot be used alone for payment, it can be safely stored and used by merchants to identify repeat customers and perform data analytics.

### BRIEF DESCRIPTION OF THE DRAWINGS

FIG. 1 is a flow diagram of an exemplary Financial Transaction system environment according to some embodiments of this invention.

FIG. 2 is a data diagram of an exemplary set of Customer Payment Information in unencrypted and in end-to-end encrypted format.

FIG. 3 is an embodiment of a Secure Device for performing the methods of FIGS. 1-2.

FIG. 4 is an embodiment of an Endpoint Registration and Decryption Servers for performing the methods of FIGS. 1-2.

### DETAILED DESCRIPTION OF THE PREFERRED EMBODIMENT

In the following description of preferred embodiments, reference is made to the accompanying drawings which form a part hereof, and in which it is shown by way of illustration specific embodiments in which the invention may be practiced. It is to be understood that other embodiments may be used and structural changes may be made without departing from the scope of the preferred embodiments of the present invention.

Embodiments of the present invention are directed to providing a system for true end-to-end encryption of financial transactions in a manner that prevents the theft and misuse of payment information weather the information is in-transit, or at rest during any point in the payment process.

### Financial Transaction Data Flow

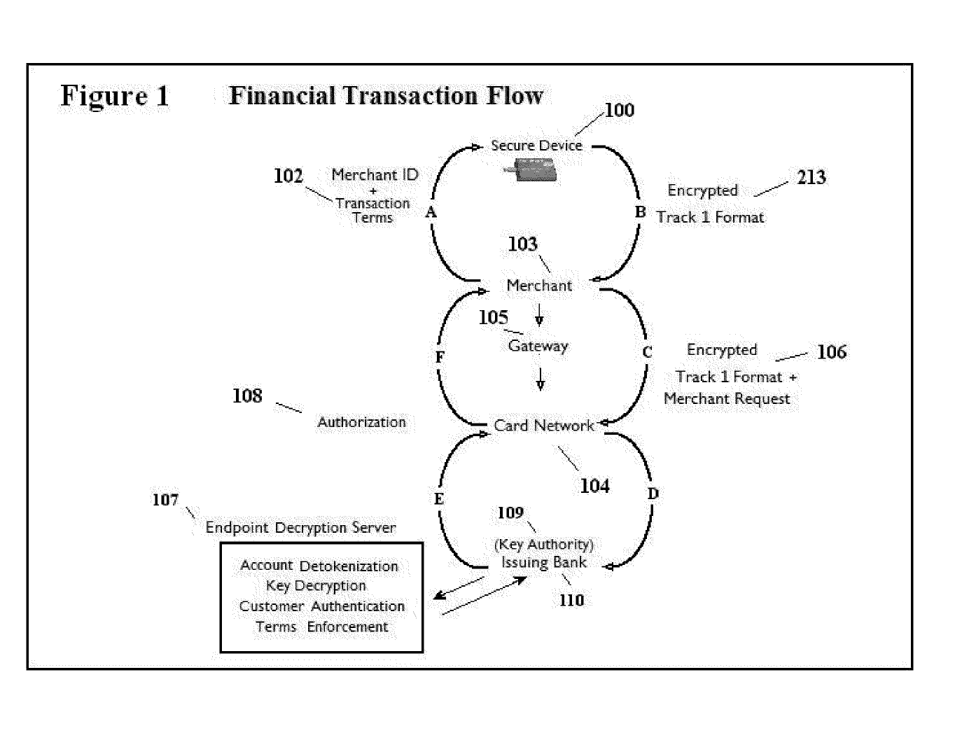

FIG. 1 is a flow diagram of the exchange of information in this type of financial transaction. The purpose of this data flow is to show a typical embodiment of how end-to-end encrypted payment information travels from a customer's secure device, to a card issuing bank.

Although FIG. 1 is the most common embodiment of how credit or debit card information is routed, a variety of other topographies are possible. The current invention is equally applicable for any type of transaction routing topography as long as the information remains encrypted while in-transit or at rest until necessary to authorize the transaction payment.

FIG. 1 illustrates some key elements of the flow that are important to show the types of information that are included in the financial payment request at various points in the process, and who has the ability to decipher the information.

The process begins when a Merchant 103 requests payment information from a customer, who in this case is the owner of a Secure Device 100 that will be used to encrypt the transaction. The Merchant 103 could be a point of sale terminal at a physical store, or could be a web site or mobile application shopping cart for processing an online transaction.

As part of the request for payment, the Merchant ID+Transaction Terms 102 are passed from the Merchant 103 to the customer Secure Device 100 (step A). In the preferred embodiment of the invention, the Transaction Terms 102 would include a variety of information to uniquely identify the Merchant 103, to uniquely identify the transaction, the amount to pay, and any additional terms such as a recurring subscription transaction, or additional amounts to approve for security deposits or incidentals.

Although some of the transaction terms are not necessary to prevent a transaction being stolen by a thief, they are important in protecting the customer from an unscrupulous merchant who may submit payment requests that have not been approved by the customer.

Thereafter, Secure Device 100 generates Encrypted Track 1 Format 213 (step B), which includes a tokenized customer account number that is used to route the transaction to the proper card issuing authority, typically the Issuing Bank 110. The message also includes the Merchant ID +Transaction Terms 102 in encrypted form.

In the preferred embodiment of the invention, the information is presented to the merchant system electronically in a standard format such as described in ISO 7813, Track 1 Format, which defines the format of payment information read from a magnetic stripe credit card. By using well established standards such as ISO 7813, the end-to-end encrypted message can be “tunneled” through existing merchant gateways and card networks with no need for additional support.

With reference to FIGS. 1, 3 and 4, Secure Device 100 transmits Encrypted Track 1 Format 213 (step B) to Merchant 103 using one of a variety of different mechanisms. First, Secure Device 100 can connect to Computer 324 (such as a desktop, notebook, or tablet computer) using a standard USB cable over USB Port 320, and can then exchange information with software embedded in a Merchant 103's web site. The exchange can be done by encoding the communication using signals sent over the Computers 324 digital audio speaker or microphone connection, or by encoding the data using generated keyboard events. The web application on the computing device is then responsible for sending the encrypted payment information to Merchant 103 over an internet connection.

Second, if Merchant 103 has provided a mobile application that allows purchases to be made, Secure Device 100 will communicate with software embedded within the mobile application to send and receive information over Connector 319 and the audio port of Mobile Device 323. The mobile application on Mobile Device 323 is then responsible for forwarding the encrypted payment information to Merchant 103 using an internet connection from Mobile Device 323.

Third, if Merchant 103 has a Point-of-Sale (POS) Device 325, Secure Device 100 will communicate with the Device 325 using a wireless protocol such as WiFi, Bluetooth, or Near-Field Communication (NFC) 321 and Wireless Transceiver 317 and will exchange information with POS Device 325, and POS Device 325 then will pass the encrypted payment information to Merchant 103's internal systems.

With reference again to FIG. 1, the Encrypted Track 1 Format 213 is combined with a merchant request and sent as Encrypted Track 1 Format+Merchant Request 106. The merchant request contains information similar to the original Merchant ID+Transaction Terms 102 that would be typically required to complete a payment transaction. For example, the merchant request will at least contain the Merchant ID and the amount of payment requested.

By having both the encrypted version of the Merchant ID+Transaction Terms 102, as well as similar information from the merchant included in Encrypted Track 1 Format+Merchant Request 106, it is possible to verify that the encrypted payment information matches the request being made from the Merchant 103, and is not payment information stolen from another transaction.

Encrypted Track 1 Format+Merchant Request 106 is passed from Merchant 103 through Gateway 105 to Card Network 104 (Step C) and finally to Issuing Bank 110 (Step D), which in this example is Key Authority 109. Issuing Bank 110 uses Endpoint Decryption Server 107 to convert the message back into a more traditional set of payment information Standard Track 1 Data 200. This involves converting the Tokenized Account #209 back into a customer Primary Account Number 203 and then decrypting the Encrypted Track 1 Data Format 213.

Issuing Bank 110 then sends confirmation to Merchant 103 through Card Network 104 (Step E) and Gateway 105 (step F).

In some embodiments of this transaction flow, the Card Network 104 (e.g. Visa, Mastercard) acts as the Key Authority 109 instead of the Issuing Bank 110. This can simplify the deployment, but leaves the customer information in an unencrypted state during part of its journey through the transaction. As long as the communication between the Card Network 104 and Issuing Bank 110 is deemed secure, this embodiment would be equally desirable.

### Track 1 Standard, Tokenized and Encrypted Formats

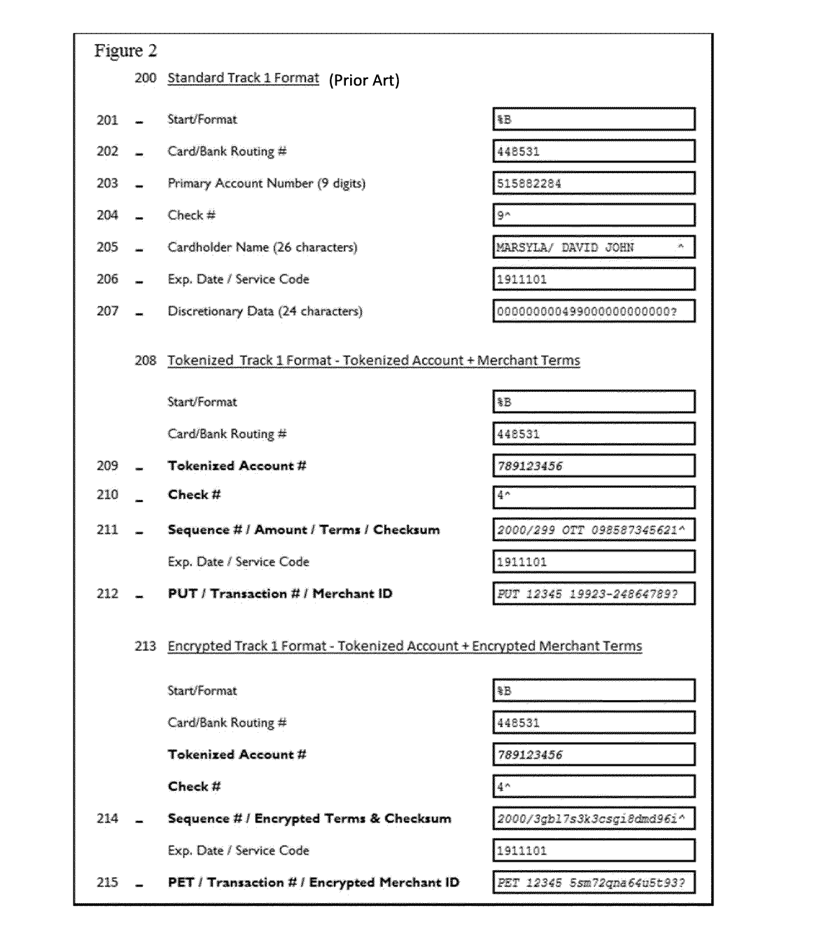

FIG. 2 is a diagram of example embodiments of the various forms of payment information that are structured using Track 1 Format. The first example, Standard Track 1 Format 200, shows how typical prior art credit card payment information would appear within Track 1 format. Track 1 format is actually transmitted as a single string of text, but to help clarify which fields contain which information, the examples have been broken into their individual fields. When standard credit card information is sent in Track 1 Format, all data is sent unencrypted.

The various data fields in Standard Track 1 Format 200 are Start/Format 201 which identifies the format as payment data, the Card/Bank Routing #202 which is the first part of a credit card number, and is used to route the transaction to the correct Issuing Bank 110. After that, is the customer's Primary Account Number 203 which along with the routing information for the bank is typically all that is needed to process a payment.

The Primary Account Number 203 is followed by a Check #204 which is used to verify the account number is in a valid format. The next field is the Cardholder Name 205, which holds the first and last name of the owner of the card. After that, there is an Exp. Date/Service Code 206 field that holds the card expiration date and some codes to determine if the card requires an unlock pin code.

Finally, there is a block of data called Discretionary Data 207 which is defined by the Issuing Bank 110 and often contains checksums or other information to help verify the card data has not been altered.

To convert a set of payment information in Standard Track 1 Format 200, into the embodiment Tokenized Track 1 Format 208, we make three important changes to the data. First, the customer Primary Account Number 203 is replaced with a Tokenized Account #209. The token is known by the Issuing Bank 110 and given to the Secure Device 100 during an initial Incoming Registration 400 process. In some cases, the Check #210 may also need to change to ensure the account number looks valid to a Merchant 103.

Next, two of the main fields in the message, Cardholder Name 205 and Discretionary Data 207 are replaced with information specific to our end-to-end encryption format. Cardholder Name 205 is replaced with Sequence #/Amount/Terms/Checksum 211.

This new field contains many pieces of information. The Sequence # identifies which encryption key was used to encode the transaction. The Amount is the amount of the transaction, Terms indicate if this is a one-time payment or if this is a recurring transaction that can be re-submitted at some defined interval. In some cases, Amount will be a value that indicates the customer has approved any amount submitted by the Merchant 103. The Checksum field is a calculated number that is generated by analyzing the entire text of Tokenized Track 1 Format 208. The same checksum will be generated inside the Endpoint Decryption Server 107 to verify that nothing within the message has been modified since it was encrypted in the Secure Device 100.

The second field that is replaced is the Discretionary Data 207 with the PUT/Transaction #/Merchant ID 212 field. The 3 character code PUT is used to indicate that this data is in the format “Pocket Unencrypted Transaction”. This is necessary so that the processing servers at the Issuing Bank 110 can quickly identify this new format of information. The Transaction # is a number generated by the Merchant 103 which can be used to identify which payment this information is associated with. This is important to prevent one encrypted payment token being stolen and used for a different transaction than it was intended. The Merchant ID is a standard identifier used to uniquely identify the Merchant 103 who submitted the payment request. This is important for preventing a stolen payment token being re-used at another Merchant 103.

The third format of this information is the Encrypted Track 1 Format 213. This is the format that is used to send data to the Merchant 103 and through the Gateway 105, Card Network 104 to the Issuing Bank 110. This format replaces Sequence #/Amount/Terms/Checksum 211 with Sequence #/Encrypted Terms & Checksum 214. These fields have now been encrypted using a unique key for the transaction and the Transaction Pad Encryption format. The Sequence # is not encrypted since it is needed to know which key was used for the encryption. Note that once a Sequence # is used for a transaction, it cannot be used for another transaction.

The final change is that the field PUT/Transaction #/Merchant ID 212 is replaced with PET/Transaction #/Encrypted Merchant ID 215. The new 3 character code PET is put in place to indicate that this is a “Pocket Encrypted Transaction”, and the Merchant ID is encrypted along with the rest of the terms and checksum. Note that the Transaction # field is not encrypted so that the Merchant 103 can reject any transaction that does not match the current transaction before sending it to the Issuing Bank 110.

Note that the format of the information shown in the example is for illustration only, and the actual format of the data replacing the Cardholder Name 205 and Discretionary Data 207 fields may be compressed or encoded in a variety of formats.

### Secure Device Processing Details

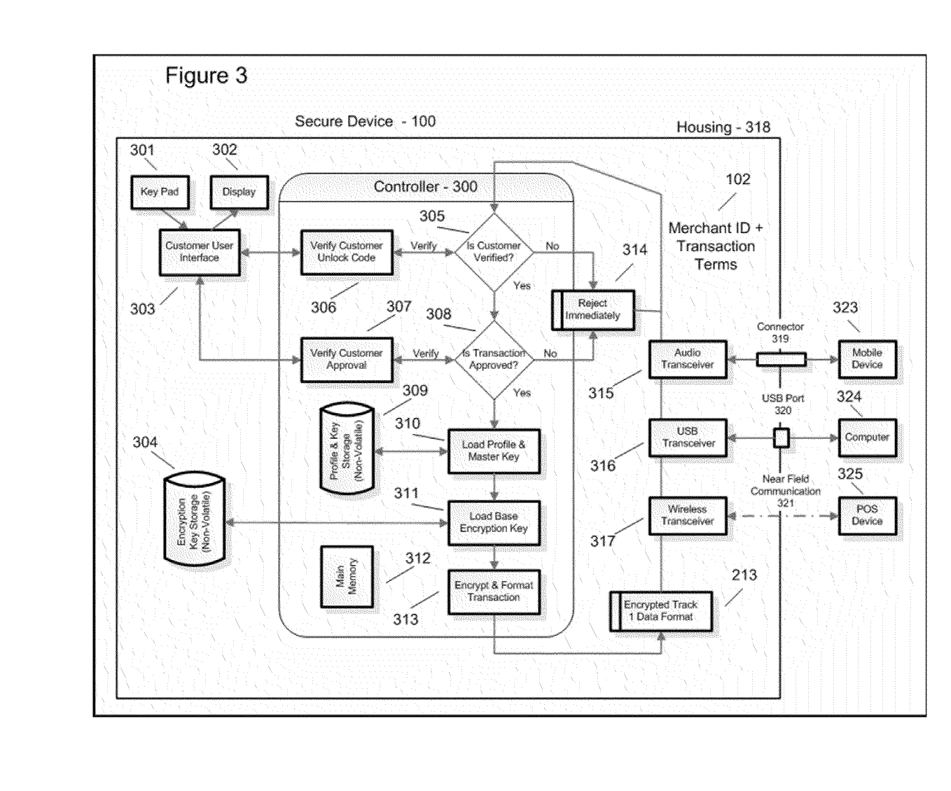

FIG. 3 depicts components of Secure Device 100. Secure Device 100 is made up of several physical components, the most important of which is the Controller 300. The Controller 300 is a processing unit that performs functions necessary for the methods described herein. Controller 300 utilizes Main Memory 312 during operation, such as to store instructions and data.

The Controller 300 utilizes two types of non-volatile storage, a local Profile & Key Storage 309 which is typically flash memory embedded directly within the Controller 300 and is small, but very secure. The second non-volatile storage utilized by Controller 300 is the Encryption Key Storage 304, which could comprise flash memory, a hard disk drive, or other media, and can be used to store the large number of encryption keys needed for each transaction. In the preferred embodiment of Encryption Key Storage 304, a small flash memory chip is used to hold more than one million 256-bit encryption keys, to be assured that the customer will have enough unique transaction keys for a lifetime of use.

The Controller 300 contains multiple methods to communicate with Merchant 103 depending on which type of payment interface is provided. If the Merchant 103 provides a mobile application that accepts payments on a Mobile Device 323, the Secure Device 100 will use Connector 319 to connect to the audio jack of the Mobile Device 323 and Audio Transceiver 315 will be used to encode/decode communication between the Controller 300 and Mobile Device 323.

If the Merchant 103 provides a web site for accepting payments on a Computer 324, the Secure Device 100 will use USB Port 320 to connect to Computer 324 using standard USB communication protocols, such as audio communication, or keyboard communication. The USB Transceiver 316 will be used to encode/decode communication between the Controller 300 and Computer 324.

If the Merchant 103 provides an in-store Point of Sale, POS Device 325 that supports accepting payment through a wireless communication protocol such as by using WiFi, Bluetooth, or NFC Near Field Communication 321. The Wireless Transceiver 317 will be used to encode/decode communication between Controller 300 and POS Device 325. Note that the communication with a POS Device 325 could be through contact based electrical signals such as those used by an EMV smart card.

At some points during the payment process, the Controller 300 will also need to communicate with the customer who is the owner of the Secure Device 100 in order to unlock the device, and to approve the transaction. There are many ways that this can be accomplished, and one example embodiment is that the Secure Device 100 has a Customer User Interface 303 comprised of a small Key Pad 301 and a small Display 302. In some embodiments, there is no Customer User Interface 303 on the device, and instead a user interface on the Mobile Device 323, Computer 324 or POS Device 325 is used, and any user input or display output is communicated through the various Transceivers, 315, 316 or 317.

The processing that is done by the Controller 300 begins when a Merchant 103 requests payment, and provides their Merchant ID +Transaction Terms 102. This information is communicated to the Controller 300 using one of the various Transceivers, 315, 316 or 317.

The first step in the process is for the Controller 300 to check Is Customer Verified 305. This step requests that the customer will Verify Customer Unlock Code 306 using a Customer User Interface 303 to display the request to the customer on Display 302 so the customer can provide an unlock code using Key Pad 301. The unlock code may be a 6 digit code, or may be some other type of password. In some embodiments of the invention, a biometric method such as a fingerprint scan could be used to unlock Secure Device 100.

Logically, the goal of requiring an unlock code is to verify that the customer who owns the device is currently in possession of it. In some embodiments, the customer may be able to disable this verification step in order to make a purchase process more convenient, but the customer will run the risk of a thief physically stealing the device and being able to make payments without restriction.

The second step in the process is to verify that the transaction terms and the payment method to use are approved by the customer, step Is Transaction Approved 308. The device will Verify Customer Approval 307 by displaying the transaction terms and default payment profile on Display 302 and waiting for the customer to approve the terms using the Key Pad 301. In some cases, the customer may decide that for certain types of transactions (such as an in-store purchase) they want to automatically use a default payment profile, and automatically approve the transaction terms in order to speed up the transaction process.

The next step in the process is to Load Profile & Master Key 310 from the local Profile & Key Storage 309. A Secure Device 100 may support dozens of different payment profiles representing different types of debit, credit or pre-paid cards. At this point, the selected profile is loaded, which contains the Tokenized Account #209 and details of the exact Encrypted Track 1 Format 213 expected by the Key Authority 109. In some cases, different Key Authorities 109 will have slightly different formats of the Track 1 data depending on how much unused space is available in Discretionary Data 207 field for the purpose of storing encrypted payment terms.

The next step in the process is to Load Base Encryption Key 311 from Encryption Key Storage 304. In some embodiments, this encryption key itself is encrypted, and the Master Key 310 is used to decrypt the encryption key before creating the encrypted transaction. The reason the encryption key may itself be encrypted, is that the Encryption Key Storage 304 is often a separate memory component, which could be removed from the Secure Device 100 and connected to another system to read its contents. If this happens, it is important that the information stored on Encryption Key Storage 304 is also obscured so that a thief cannot use this information to generate new encrypted transactions without also having the Master Key 310, which is much more difficult to access since it is stored in flash memory inside of the Controller 300.

Finally, the Controller 300 will Encrypt & Format Transaction 313 into Encrypted Track 1 Format 213. The Encrypt & Format Transaction 313 process follows a couple of simple steps to perform the encryption.

First, the Tokenized Account #209 is added into the profile and the Check #210 is re-computed. Next the Sequence #211 of the encryption key being used is added to the text. This is necessary so the Issuing Bank 110 knows which key to use to decrypt the message. Next the Merchant ID+Transaction Terms 102 are added to the proper places in fields 211 and 212. Next, Checksum 211 is generated based on the entire text of Tokenized Track 1 Format 208 and stored into field 211.

Finally, some of the key data within the transaction fields 211 and 212 are encrypted using our selected encryption key. The preferred encryption process to follow is using Transaction Pad Encryption, but other types of encryption which utilize the unique encryption key may be equally valid. Transaction Pad Encryption will apply the key to the data being encrypted, and then scramble the data using the encryption key, as well as a hidden key to make the scramble more difficult to decode.

The Encrypted Track 1 Format 213 is then sent to the Merchant 103 using the various Transceivers, 315, 316 or 317. At this point, the Secure Device 100 has completed its part of the end-to-end encryption, and it is up to the Merchant 103 to pass the data to the Gateway 105 so it can be properly routed to Issuing Bank 110 where it can be interpreted by the bank's Endpoint Decryption Server 107.

### Endpoint Registration and Decryption Servers

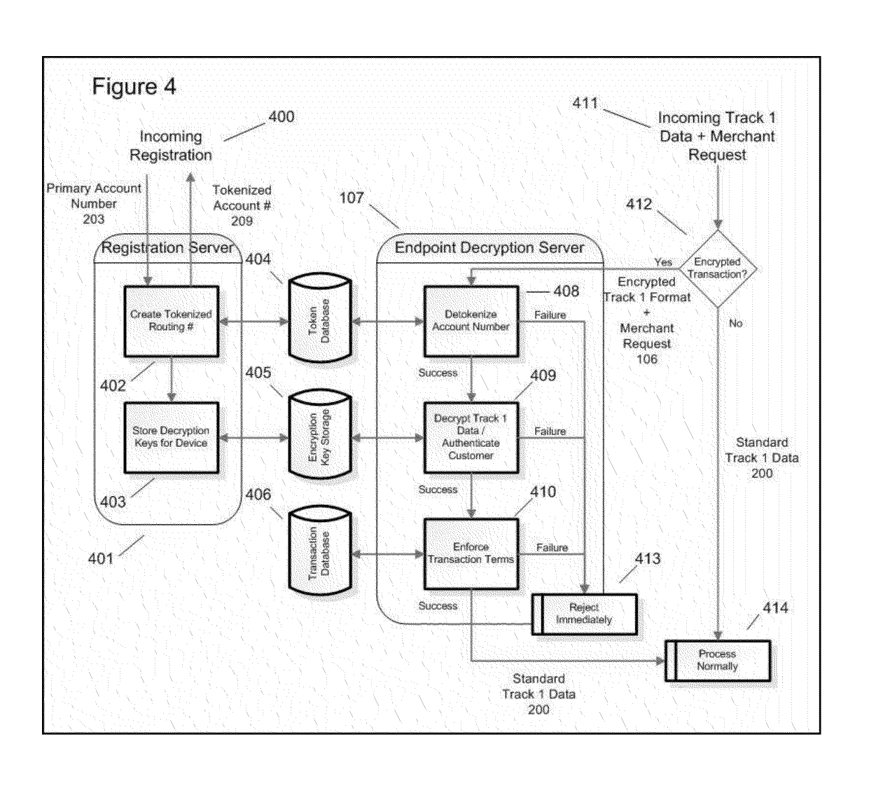

FIG. 4 depicts components of Endpoint Decryption Server 107 and Registration Server 401 which are processing servers managed by the Key Authority 109 which is typically the Issuing Bank 110. These servers are responsible for registering a Secure Device 100 with the Key Authority 109 when an Incoming Registration 400 request comes in for the device, and then processing Encrypted Track 1 Format 213 when it is submitted from the Secure Device 100 as part of a payment to a Merchant 103.

The Registration Server 401 is not part of the actual payment processing of the end-to-end encryption but is included to illustrate how a Tokenized Account #209 is created from a Primary Account Number 203. When a Secure Device 100 is first associated with a payment card profile, it must register with the Key Authority 109 and have a Tokenized Account #209 along with other payment profile information returned to the Secure Device 100 and placed in Profile & Key Storage 309.

The first step of the registration process occurs when Incoming Registration 400 is sent to the Registration Server 401. There are many ways that this registration could be initiated, but a typical process would be that a customer logs into their Issuing Bank 110 web site and follows a registration process where they select the account to include on their device. The Issuing Bank 110 web site might then initiate the registration with the Registration Server 401 passing the Primary Account Number 203 to the server and then communicating the payment profile along with the Tokenized Account #209 back to the Secure Device 100.

The Registration Server 401 will take the incoming Primary Account Number 203 and store it in a Token Database 404. The Token Database 404 may be a separate server used to manage information or may simply be a local file system used to store and retrieve structured information. It will then initiate step Create Tokenized Routing #402 which will generate a unique, unused number that looks similar to a credit card Primary Account Number 203 but cannot be used alone for making purchases. The generated token is then also stored in Token Database 404 so that the Primary Account Number 203 can be retrieved at a later time when the token is presented as part of Encrypted Track 1 Format 213.

Next, the Registration Server 401 will Store Decryption Keys for Device 403 into its Encryption Key Storage 405. The Encryption Key Storage 405 may be a separate server used to manage information or may simply be a local file system used to store and retrieve structured information. The exact process of how the encryption keys that have been pre-loaded on the device are shared with the Key Authority 109 can be quite complex, but in a typical embodiment of the invention, the keys are created by the device manufacturer, and a sub-set of the keys are electronically shared with the Key Authority 109 when a customer requests to create a card profile on their Secure Device 100.

The Endpoint Decryption Server 107 is responsible for processing any end-to-end encrypted transactions which are submitted to the Key Authority 109. The process starts when any payment request is submitted to the Key Authority 109 as Incoming Track 1 Data +Merchant Request 411. The first thing that must be determined is if this is an Encrypted Transaction 412 or a standard transaction. If the format of the information is Standard Track 1 Format 200, then the transaction continues on to Process Normally 414 and Endpoint Decryption Server 107. A standard process for payment authorization requires the Issuing Bank 110 to look up the customer account and determine if they have enough funds or credit to approve the transaction.

If the Incoming Track 1 Data+Merchant Request 411 is in Encrypted Track 1 Format 213, then the payment information along with the merchant request Encrypted Track 1 Format +Merchant Request 106 is passed to the Endpoint Decryption Server 107 in order to convert the information back into Standard Track 1 Format 200 that can continue on to Process Normally 414. If any step of the decryption process fails, the payment will be sent to Reject Immediately 413 indicating that there is some problem with the encrypted payment request.

The first step performed by the Endpoint Decryption Server 107 is to Detokenize Account Number 408 by mapping the Tokenized Account #209 to the Primary Account Number 203 which would be expected in Standard Track 1 Format 200. If there is a problem looking up the token because it is invalid, this step can fail. In some embodiments, additional information that would have been present in the original Cardholder Name 205 or Discretionary Data 207 fields is also retrieved so that they can be replaced when converting from Tokenized Track 1 Format 208 to Standard Track 1 Format 200.

The next step is to Decrypt Track 1 Data/Authenticate Customer 409. The Encryption Key Storage 405 is used to look up the unique key to use for the decryption by combining the Tokenized Account #209 and the Sequence #211 as an index into the stored set of keys.

Once the decryption key has been identified, the information within Encrypted Track 1 Format 213 is extracted and the reverse Transaction Pad Encryption process is used to unscramble and decrypt the information to covert the data to Tokenized Track 1 Format 208. The Checksum 211 is then re-calculated to determine if it matches the version of the Checksum 211 that was encrypted as part of the transaction data.

If our re-calculated Checksum 211 is a match, we can be assured that no information in the transaction has been modified, and that our decryption was successful using the unique key that could only be available on the customer's Secure Device 100. The matched Checksum 211 is enough information for us to be sure that this transaction is authentic. Any failure for the checksums to match will result in Reject Immediately 413.

Finally we Enforce Transaction Terms 410 by comparing the Merchant ID +Transaction Terms 102 that were encrypted within our Encrypted Track 1 Format 213 with the Merchant Request passed in our Encrypted Track 1 Format +Merchant Request 106 data that was passed to the Endpoint Decryption Server. Some mismatch of terms can be immediately identified, such as the Merchant ID not being correct, but other mismatches will require us to look up this transaction in our Transaction Database 406. The Transaction Database 406 may be a separate server used to manage information or may simply be a local file system used to store and retrieve structured information.

We can use the same combination of Tokenized Account #209 and the Sequence #211 as an index into the Transaction Database 406 to find the transaction. If the transaction terms identify this transaction as a one-time payment, we need to verify that we have not previously approved this payment. If a one time payment has been previously approved for the full amount, then we will fail at this point and Reject Immediately 413 no matter what amount is requested from the Merchant 103. It is also possible that a larger payment was approved by the customer, but the Merchant 103 has chosen to capture the full amount with multiple requests. For example, booking a hotel room may require a deposit when initially booked, and then a final payment during checkout. As long as the customer approved amount is enough for both of these, the Merchant 103 can request these payments at different times using the same Encrypted Track 1 Format 213.

Once all processing steps have been completed by the Endpoint Decryption Server 407, the information has been converted back to something compatible with Standard Track 1 Format 200 and the Issuing Bank 110 can now Process Normally 414 the transaction to verify the customer has sufficient funds or credit before providing Authorization 108 back to the Merchant 103.

1. A method for encrypting financial payment information, comprising;
storing, on a non-volatile storage device within a first device, a plurality of one-time use encryption keys, each key associated with a unique key identifier;
receiving, by the first device, transaction terms from a second device, the transaction terms comprising a customer identifier, a merchant identifier, a transaction identifier, and a transaction amount;
reading a one-time use encryption key from the one of the plurality of one-time use encryption keys from non-volatile storage in the first device;
generating, by the first device, an encrypted message using the transaction terms and the selected one-time use encryption key, wherein the selected one-time use encryption key had not previously been used by the first device to generate an encrypted message; and
sending, by the first device or the second device, the encrypted message and an associated unique key identifier to a third device.

2. The method of claim 1, wherein the second device is a point-of-sale device.

3. The method of claim 1, wherein the third device is a server.

4. The method of claim 1, wherein each of the plurality of one-time use encryption keys contains more bits than the data that is encrypted into the encrypted message.

5. The method of claim 1, wherein the encrypted message complies with the ISO 7813 Track 1 data format.

6. A portable hand-held device for encrypting financial transaction information, comprising:
a housing;
a connector;
a processing unit within the housing; and
non-volatile storage within the housing and coupled to the controller, the non-volatile storage storing a plurality of one-time use encryption keys, each key associated with a unique key identifier;
wherein the processing unit is configured to:
receive transaction terms comprising a customer identifier, a merchant identifier, a transaction identifier, and a transaction amount;
generate an encrypted message using the transaction terms and one of the plurality of one-time use encryption keys, while ensuring that the one of the plurality of one-time use encryption keys has not been used previously by the device to generate an encrypted message and will not be used in the future by the device to generate an encrypted message; and
transmit the encrypted message and an associated unique key identifier to another device.

7. The device of claim 6, wherein the connector comprises an audio connector capable of being used by the device to transmit the encrypted message to another device.

8. The device of claim 6, wherein the non-volatile storage comprises flash memory.

9. The device of claim 6, wherein the transaction terms comprise a customer identifier, a merchant identifier, a transaction identifier, and a transaction amount.

10. The device of claim 6, wherein the onetime use encryption key contains more bits than data that is encrypted into the encrypted message.

11. The device of claim 6, wherein the encrypted message complies with the ISO 7813 Track 1 data format.

12. A system for decrypting financial transaction information, comprising:
a server comprising a processing unit and non-volatile storage storing a plurality of one-time use encryption keys associated with a device, each key associated with a unique key identifier, the processing unit configured to decrypt a received encrypted message generated in response to a transaction performed by the device using one of the plurality of one-time use encryption keys selected from non-volatile storage based upon a received unique key identifier to obtain terms of the transaction comprising a customer identifier, a merchant identifier, a transaction identifier, and a transaction amount.

13. The system of claim 12, wherein the transaction terms comprise a customer identifier, a merchant identifier, a transaction identifier, and a transaction amount.

14. The system of claim 12, wherein the encrypted message is received by the server from a credit card network.

15. The system of claim 12, wherein the one-time use encryption key is larger than the data that is encrypted into the encrypted message.

16. The system of claim 12, wherein the encrypted message complies with the ISO 7813 Track 1 data format.

17. A method for encrypting financial payment information, comprising;
storing, in non-volatile storage on a first device and non-volatile storage on a third device, a plurality of one-time use encryption keys, each key associated with a unique key identifier;
receiving, by the first device, transaction terms from a second device, the transaction terms comprising a customer identifier, a merchant identifier, a transaction identifier, and a transaction amount;
reading one of the plurality of one-time use encryption keys from non-volatile storage in the first device;
generating, by the first device, an encrypted message using the transaction terms and the one of the plurality of one-time use encryption keys;
one of sending, by the first device, the encrypted message and a unique key identifier associated with the one of the plurality of one-time use encryption keys to a third device, or sending, by the first device, the encrypted message and a unique key identifier associated with the one of the plurality of one-time use encryption keys to the second device and sending, by the second device, the encrypted message and a unique key identifier associated with the one of the plurality of one-time use encryption keys to a third device;
selecting one of the plurality of one-time use encryption keys from non-volatile storage in the third device using the unique key identifier; and
decrypting, by the third device, the encrypted message using the one of the plurality of one-time use encryption keys to obtain the transaction terms.

18. The method of claim 17, wherein the second device is a point-of-sale device.

19. The method of claim 17, wherein the third device is a server.

20. The method of claim 17, wherein the onetime use encryption key contains more bits than the data that is encrypted into the encrypted message.

21. The method of claim 17, wherein the encrypted message complies with the ISO 7813 Track 1 data format.
